(19) United States
(12) Patent Application Publication
(10) Pub. No.: US 2026/0243560 A1
(43) Pub. Date: Aug. 20, 2026

(54) STACKED SHEET CURVED SURFACE DEFORATION MEASUREMENT DEVICE AND METHOD THEREOF BASED ON MULTI-CONTACT MICRO-REFLECTOR

(71) Applicant: HUAZHONG UNIVERSITY OF SCIENCE AND TECHNOLOGY, Hubei (CN)

(72) Inventors: Jinlong Zhu, Hubei (CN); Xiangyu ZHAO, Hubei (CN)

(73) Assignee: HUAZHONG UNIVERSITY OF SCIENCE AND TECHNOLOGY, Hubei (CN)

(21) Appl. No.: 18/839,731

(22) PCT Filed: Oct. 12, 2023
(86) PCT No.: PCT/CN2023/124133

§ 371 Date: Aug. 20, 2024

(30) Foreign Application Priority Data
Sep. 26, 2023 (CN) 202311252093.2

(51) Int. Cl. G01B 11/24; G01B 11/255

(52) U.S. Cl. CPC G01B 11/2441; G01B 11/255; G01B 2210/56

(57) ABSTRACT

Disclosed are a stacked sheet curved surface deformation measurement device and a method based on a multi-contact micro-reflector. The measurement device includes a light source, an array mask, an optical splitter, a reflector, a multi-contact micro-reflector, and a camera. The optical splitter is disposed behind the light source. The array mask is disposed between the optical splitter and the light source. The reflector and the multi-contact micro-reflector are disposed behind the optical splitter. The stacked sheet to be tested is disposed behind the multi-contact micro-reflector. The array mask is configured to divide light emitted by the light source into multiple parallel incident light beams according to the mask array distribution. One beam is configured to detect a single stacked sheet curved surface deformation. Multiple micro-reflectors are disposed at a front end of the multi-contact micro-reflector. During measuring, a single micro-reflector extends between adjacent stacked sheets to be tested for detection.

### TECHNICAL FIELD

The disclosure relates to a technical field of three-dimensional surface morphology measurement, and in particular to a stacked sheet curved surface deformation measurement device and a method thereof based on a multi-contact micro-reflector.

### RELATED ART

There are many layers of stacked wafers. Under the influence of environmental stress such as high temperature and high pressure, the wafers may experience certain warping and bending, and the performance of the device may be greatly affected. At this time, the change in the surface morphology of each wafer in the stacked wafer needs to be measured accurately in order to grasp the deformation of the device in real time and then predict the performance lifetime of the device. The interval between the stacked wafers is generally a few microns to a few millimeters, and conventional technical methods are difficult to measure such a tiny interval. In addition to the current measurement problems of the stacked wafers, stacked metal sheets, laser-processed metal gaps, laminated materials, and other stacked objects with tiny intervals may have this measurement difficulty. Therefore, a high-precision and high-efficiency measurement device and surface morphology fitting method are needed to solve the measurement problem of stacked sheet gaps.

Currently, the gap measurement of the metal material is generally carried out by a probe discharge measurement method, that is, a probe with an external DC voltage is moved radially by clicking. When the probe moves toward the object to be measured until discharge occurs, a difference between a probe stroke and the initial installation gap is a gap distance. This measurement method is within a wide margin of error and a small range, and is only suitable for conductive materials such as metals. However, the conventional detection methods do not have good measurement capabilities for the widespread nanoscale measurement of the stacked sheet gaps in a range of several microns to several millimeters or even larger.

Therefore, a measurement system is developed which can accurately detect the deformation of the stacked sheet. The deformation of the stacked sheet may be measured and evaluated with high efficiency and high precision. The surface morphology of each thin sheet in the stacked sheets may be fitted by using the measured data and algorithms, which is beneficial to timely discovering the morphological changes of the thin sheet in the stacked sheet, predicting the performance lifetime of the device, and improving the utilization efficiency of the device.

### SUMMARY OF INVENTION

In view of the above defects or improvement needs of the related art, the disclosure provides a stacked sheet curved surface deformation measurement device and a method thereof based on a multi-contact micro-reflector to solve the problem of simultaneously measuring the curved surface deformation of multiple stacked sheets in the stacked sheet.

To achieve the above object, according to one aspect of the disclosure, a stacked sheet curved surface deformation measurement device based on a multi-contact micro-reflector is provided. The measurement device includes a light source, an array mask, an optical splitter, a reflector, a multi-contact micro-reflector, and a camera, where the optical splitter is disposed behind the light source, the array mask is disposed between the optical splitter and the light source, the reflector and the multi-contact micro-reflector are both disposed behind the optical splitter, and a stacked sheet to be measured is disposed behind the multi-contact micro-reflector; the array mask is configured to divide light emitted by the light source into multiple beams of parallel incident light according to a distribution of the array mask, and one beam of light is configured to detect a curved surface deformation of a single stacked sheet, multiple micro-reflectors are disposed at a front end of the multi-contact micro-reflector, a single micro-reflector extends between adjacent stacked sheets to be measured for detection during a measurement process, and intervals between the plurality of micro-reflectors are set up according to gaps between the adjacent stacked sheets in the stacked sheet to be measured; the light emitted by the light source is divided into several beams of parallel light by the array mask, and one of the beams of the parallel light is divided into two beams of light in different directions by the optical splitter, one beam enters the reflector to be reference light, and the other beam enters a micro-reflector of the multi-contact micro-reflector to be measurement light, the measurement light is reflected by the multi-contact micro-reflector, irradiates a surface of the stacked sheet to be measured, and is reflected by the stacked sheet to be measured, and the reflected light returns to the optical splitter along an original path, the reference light is reflected by the reflector and meanwhile enters the optical splitter, and the reference light and the measurement light are reflected by the optical splitter and enter the camera to merge to form an interference pattern.

Further, according to a preferred embodiment of the disclosure, a surface of the array mask has a linear array of pinholes, and a distance between pinhole arrays corresponds to a contact interval of the multi-contact micro-reflector.

Further, according to a preferred embodiment of the disclosure, the multi-contact micro-reflector includes a substrate and multiple contacts disposed on the substrate, the substrate is made of a light-transmitting material, and a bottom surface of each of the contacts is in contact with a surface of the substrate.

Further, according to a preferred embodiment of the disclosure, the contact is a micro rectangular prism, a hypotenuse of the micro rectangular prism is a micro-reflector, light is incident from a side of the substrate, enters the micro-reflector from a right-angle edge of the micro rectangular prism, is reflected by the micro-reflector, and irradiates the surface of the stacked sheet to be measured, and the reflected light after being reflected by the surface of the stacked sheet to be measured irradiates the micro-reflector and returns along an original path.

Further, according to a preferred embodiment of the disclosure, the contact is a micro-channel prism, the micro-channel prism includes two micro-channels, a connection section between the two micro-channels is a right-angled slope, the right-angled slope is a micro-reflector, light incident from the bottom surface of the substrate enters one of the two micro-channels, enters the other one of the two micro-channels after being reflected by the micro-reflector, and reaches the surface of the stacked sheet to be measured after propagating in the other one of the two micro-channels, and the reflected light after being reflected by the surface of the stacked sheet to be measured irradiates the micro-reflector and returns along an original path.

Further, according to a preferred embodiment of the disclosure, the substrate includes a clamp part and a transition part, the clamp part is configured to clamp the contact, the transition part is configured to connect the contact and the clamp part, a micro-plane reflector is disposed at a front end of the contact, and the micro-plane reflector is a micro-reflector.

Further, according to a preferred embodiment of the disclosure, the micro-plane reflector is based on a brittle sheet material, a silver film or an aluminum film is coated on a surface, a layer of silicon dioxide protective film is attached to a surface of the silver film or the aluminum film, and a size of the contact is 1 um to 10 mm.

Further, according to a preferred embodiment of the disclosure, the stacked sheet to be measured is a stacked sheet object comprising a stacked semiconductor wafer, a stacked metal sheet, or a stacked chip.

Further, according to a preferred embodiment of the disclosure, the measurement device further includes a first translation stage, a second translation stage, and a third translation stage, the first translation stage is disposed below the reflector for adjusting a position of the reflector, the second translation stage is disposed below the multi-contact micro-reflector for adjusting a position of the multi-contact micro-reflector, and the third translation stage is configured to place the stacked sheet to be measured, and a rotation or a movement of the third translation stage drives the stacked sheet to be measured to rotate or move.

According to another aspect of the disclosure, a measuring method by the measurement device is provided. The method includes following steps. S1: positions of the reflector and the multi-contact micro-reflector are adjusted to form a plurality of interference patterns in the camera, where each contact of the multi-contact micro-reflector is located between adjacent stacked sheets to be measured. S2: A distance between a reflection spot of light of the multi-contact micro-reflector and a reflection spot of light on the surface of the stacked sheet to be measured are calculated, that is an elevation value at the reflection spot on the surface of the stacked sheet to be measured. S3: the stacked sheet to be measured is rotated, a rotation angle is recorded, and the steps S1 to S2 are repeated until elevation values of multiple reflection spots on each surface of the stacked sheet to be measured are obtained. S4: the reflection spots are fitted to obtain a curved surface of the stacked sheet to be measured by using the elevation value of each reflection spot and the rotation angle, and a determination whether the surface of the stacked sheet to be measured is deformed according to the fitting curved surface is made. In step S3, the elevation is further used to calculate an inclination angle of the reflection spot, and the inclination angle of the reflection spot is calculated according to a following relation:

$$θ = \frac{1}{2} arc tan ( \frac{2 h - \sqrt{2} {l}_{1}}{2 {l}_{2} - \sqrt{2} {l}_{1}} )$$

where h is a distance in which the reflected light of the light path calculated by the camera deflects in a Y direction relative to the reflected light of the reference light path, l₁=

$${h}_{1} ( \frac{sin 2 θ}{sin ( \frac{π}{4} - 2 θ )} ) ,$$

h₁ is a distance in which a point of the light beam is incident on the multi-contact micro-reflector to a reflection spot of the stacked sheet to be measured, and l₂ is a sum of a distance between the multi-contact micro-reflector and the optical splitter and a distance between the optical splitter and the camera. During a fitting process, a fitting method is further determined according to the inclination angle of the reflection spot, and a two-dimensional Griddata interpolation algorithm is used for fitting if the inclination angle is less than a preset threshold, otherwise, a cubic polynomial fitting algorithm is used.

Based on the above, compared with the conventional method in the related art, the technical solution of the disclosure has the following beneficial effects:
1. The disclosure adopts the pinhole array mask and a multi-contact micro-reflector. The pinhole array mask is configured to divide the light into multiple beams. Each beam of light forms a separate interference pattern after passing through the optical splitter reflector and a single micro-reflector of the multi-contact micro-reflector. Multiple beams of parallel light may simultaneously measure the surface of the stacked sheet to be measured, thereby achieving simultaneous measurement of the surfaces to be measured and improving measurement efficiency.
2. The stacked sheet to be measured of the disclosure has a narrow gap, generally between a few microns and a few millimeters. The conventional gap measurement is mainly based on a mechanical method of probe conductivity measurement, and the measurement scene is very limited. The disclosure is based on an optical measurement principle and collects the reflected light data of the stacked sheet by the multi-contact micro-reflector to obtain the deformation of the stacked sheet. The measurement precision is high and the applicability is strong.
3. The size of the micro-reflector contact of the multi-contact micro-reflector of the disclosure is generally 1 um to 10 mm. The size is designed according to the gap between the stacked sheets to be measured, and is adapted to the measurement requirements of different gap distances between the stacked sheets. The micro-reflector contact of the multi-contact micro reflector corresponds to the design of the pinhole array mask, so that the parallel light emitted by the micro-reflector may accurately be incident on the contact in each multi-contact micro-reflector to measure the surface deformation of each stacked sheet to be measured in the stacked sheets. When measuring stacked sheets with different gaps, the measurement device only needs to replace the pinhole array mask and the multi-contact micro-mirror corresponding to the gap size of the stacked sheets, which increases a use range of the measurement device and improves the use efficiency of the measurement device.
4. The measuring method of the disclosure is based on an interference principle. The elevation data and the angle data of multiple measurement points on each stacked sheet in the stacked sheets may be obtained by simply operating the measurement device. The deformation of the measured stacked sheet may be obtained by using the two-dimensional Griddata interpolation algorithm and the cubic polynomial fitting algorithm. The measuring method is simple and reliable, the precision is guaranteed, and the repeatability is high.

### BRIEF DESCRIPTION OF DRAWINGS

FIG. 1 is a schematic diagram of a stacked sheet curved surface deformation measurement device according to a preferred embodiment of the disclosure.

FIG. 2 is a schematic diagram of a tilt angle measurement principle of a reflection spot of a stacked sheet according to a preferred embodiment of the disclosure.

FIG. 3 is a schematic diagram of a structure of a multi-contact micro-reflector according to a preferred embodiment of the disclosure.

FIG. 4 is a schematic diagram of a structure of a multi-contact micro-reflector according to another preferred embodiment of the disclosure.

FIG. 5 is a schematic diagram of a structure of a multi-contact micro-reflector according to another preferred embodiment of the disclosure.

FIG. 6 is a diagram of a fitting result of torsional and bending deformation of a curved surface of a thin sheet according to the preferred embodiment of the disclosure.

FIG. 7 is a diagram of a fitting result of uneven, torsional, and bending deformation of a curved surface of a thin sheet according to a preferred embodiment of the disclosure. Throughout the drawings, the same reference numerals are used to denote the same elements or structures, where: 1—light source, 2—array mask, 3—optical splitter, 4—first translation stage, 5—reflector, 6—reference light path, 7—camera, 8—second translation stage, 9—multi-contact micro-reflector, 10—measurement light path, 11—stacked sheet to be measured, 12—third translation stage, 13—clamp part, 14—contact, 15—transition part, 16—substrate, 17—micro-reflector, 18—single stacked sheet, 19—reflection spot, 20—tangent line of reflection spot on the stacked sheet, 21—camera display screen, 22—light beam reflected from the reference light path to the camera, and 23—light beam reflected from the measurement light path to the camera.

### DESCRIPTION OF EMBODIMENTS

In order to make the purpose, technical solutions, and advantages of the disclosure comprehensible, the disclosure is further described in detail below in conjunction with the accompanying drawings and embodiments. It should be understood that the specific embodiments described herein are only used to explain the disclosure, and are not used to limit the disclosure. In addition, the technical features involved in the various embodiments of the disclosure described below can be combined with each other as long as they do not conflict with each other.

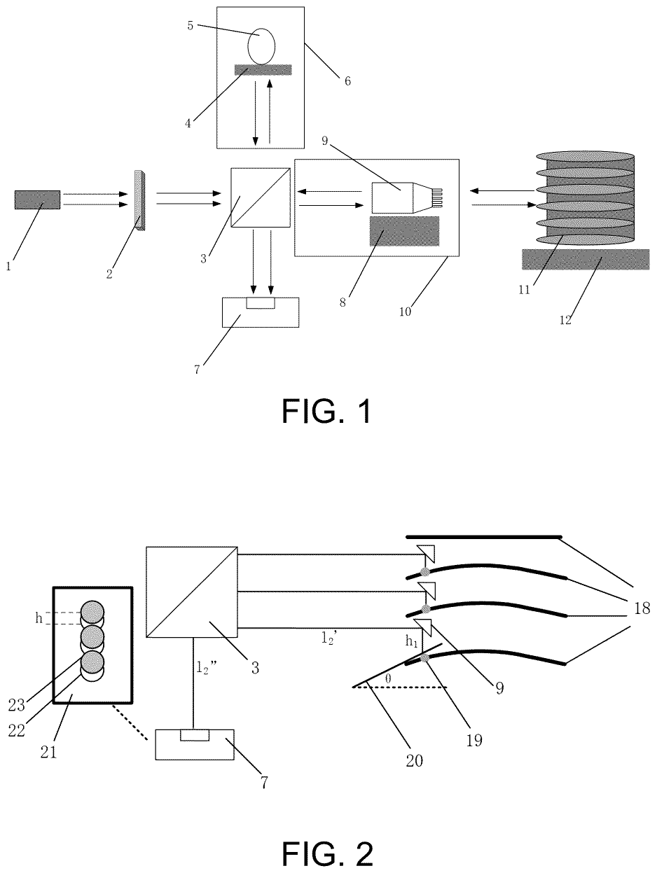

As shown in FIG. 1, a measurement device for a stacked sheet gap includes a light source 1, a pinhole array mask 2, an optical splitter 3, a first translation stage 4, a reflector 5, a second translation stage 8, and a multi-contact micro-reflector 9. The optical splitter 3 is configured to connect a reference light path 6 and a measurement light path 10, where the reference light path 6 is located in a direction of a reflection light path of the light source 1 and the optical splitter 3, and the measurement light path 10 is located in a direction of a transmission light path of the light source 1 and the optical splitter 3. A first translation stage 4 is disposed on the reference light path 6. The reflector 5 is mounted on the first translation stage 4. The reflector 5 is configured to reflect the light source 1 on the reference light path 6 to the optical splitter 3. A second translation stage 8 is disposed on the measurement light path 10. The multi-contact micro-reflector 9 is mounted on the second translation stage 8. The multi-contact micro-reflector 9 is configured to reflect the light source 1 on the measurement light path 10 to the stacked sheet and reflect the reflected light on the stacked sheet to the optical splitter 3. A stacked sheet 11 to be measured is placed on a third translation stage 12. The third translation stage 12 rotates to drive the stacked sheet 11 to be measured to rotate.

The multi-contact micro-reflector 9 may measure an interference signal from the micro-reflector to a wafer. Especially when an interval between stacked wafers is generally a few micrometers to a few millimeters, the deformation of each wafer of the stacked sheets may be measured efficiently and accurately based on the structure of the multi-contact micro-reflector 9 of the disclosure.

A surface of the array mask 2 has a linear array of pinholes. A distance between the pinhole arrays corresponds to a contact interval of the multi-contact micro-reflector.

The multi-contact micro-reflector 9 includes a substrate 16 and multiple contacts. A bottom surface of each contact is attached to the substrate 16.

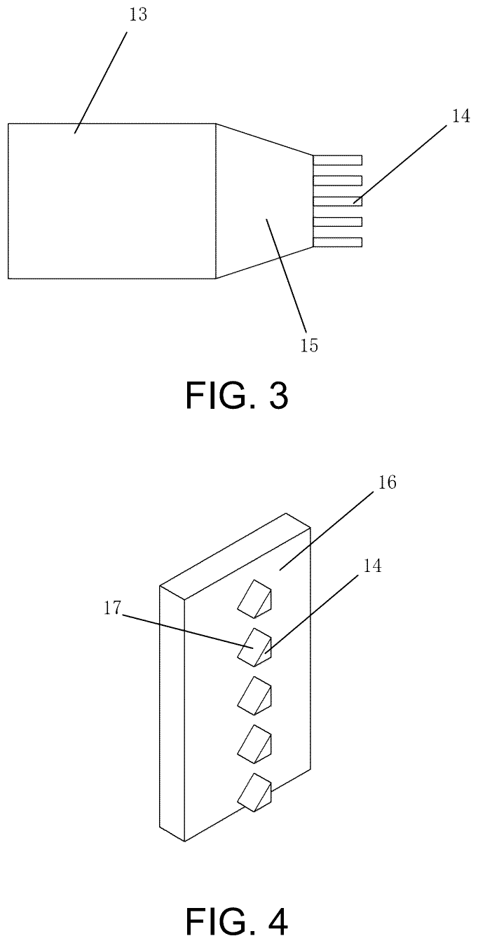

As shown in FIG. 3, the substrate 16, as an embodiment of the disclosure, includes a clamp part 13 and a transition part 15. The clamp part 13 is configured to clamp the contact. The transition part 15 is configured to connect the contact and the clamp part 13, and prevents a metal substrate 16 from being excessively bent. A micro plane reflector is disposed at a front end of the contact 14. The clamp part 13 of the multi-contact micro-reflector 9 with the sheet-shaped silver-plated plane is fixed by a fixture on the measurement light path 10. The contact 14 extends into the gap between the stacked sheets. The transition part 15 prevents the metal substrate 16 from being excessively bent.

The front end of the contact 14 is provided with a micro-reflector 17, which is a micro-plane reflector. The micro-plane reflector is a sheet-shaped silver-plated plane reflector with a brittle sheet material such as metal or glass as a substrate, and a silver film or aluminum film is coated on the surface. A layer of silicon dioxide protective film is attached to the surface of the silver film or aluminum film.

As shown in FIG. 4, the substrate 16, as another embodiment of the disclosure, is made of a light-transmitting material, which may be a glass substrate. The substrate 16 of the multi-contact micro-reflector 9 in a micro rectangular prism array is fixed by a fixture on the measurement light path 10, and the micro rectangular prism array extends into the gap between the stacked sheets. The contact is a micro rectangular prism. A hypotenuse of the micro rectangular prism is a micro-reflector 17. Light is incident from a side of the substrate 16, enters the micro-reflector 9 from a right-angle side of the micro rectangular prism, and irradiates the surface of the stacked sheet to be measured after being reflected by the micro-reflector 9. The reflected light after being reflected by the surface of the stacked sheet to be measured irradiates the micro-reflector 9, and then returns along the original path.

The micro rectangular prism array is a photoresist silicon oxide material, etc. The micro rectangular prism is a right angle triangular prism with a right angle side size of 1 um to 10 mm, and is manufactured on a glass substrate 16 by using a photolithography or a two-photon polymerization printing technology.

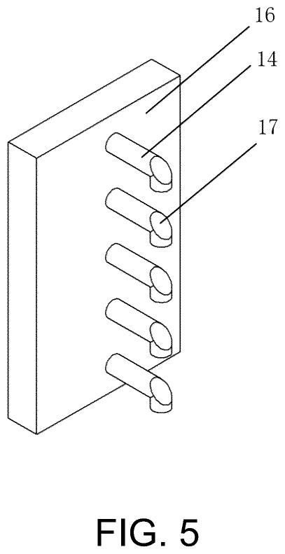

As shown in FIG. 5, the substrate 16, as another embodiment of the disclosure, is made of a light-transmitting material, which may be a glass substrate. The contact is a micro-channel prism including two micro-channels, and the connection section between the two micro-channels is a right-angled slope, which is a micro-reflector 17. The micro-channel prism 18 extends vertically into the gap between the stacked sheets. Light beam is incident from a back of the substrate 16, and is totally reflected by the right-angled surface of the micro-channel prism 18 to the stacked sheet to be measured. Afterwards, the light beam is then reflected again by the right-angled surface of the micro-channel prism 18 and reflected back, thereby obtaining the curved surface information of the stacked sheet to be measured.

The micro-channel prism array with a single size of 1 um to 10 mm is made of materials such as photoresist and silicon oxide on the substrate by using the two-photon polymerization printing technology.

The measurement object of the disclosure is a stacked sheet object, including but not limited to a stacked semiconductor wafer, a stacked metal sheet, a stacked chip, etc.

As a preferred embodiment of the disclosure, the light source 1 is a parallel light source, or may include multiple light sources and parallel light adjusted by multiple lenses.

As a preferred embodiment of the disclosure, the measurement device further includes an observation camera disposed in an opposite direction of the reference light path 6. In the actual measurement, the device further includes a controller and a processing terminal. One end of the controller is connected to the third translation stage 12, and the other end of the controller is connected to the processing terminal.

As a preferred embodiment of the disclosure, the measurement device in FIG. 1 further has a light-shielding housing surrounding all components outside a wafer box to prevent external light from affecting the measurement results.

FIG. 1 also shows a stacked sheet box. When the stacked sheet is undergoing tests, the sheet to be measured is placed in the stacked sheet box. The stacked sheet box is only used as the measurement device for testing the measurement performance. When the measurement device is actually used, the object to be measured is a finished stacked sheet such as a stacked chip which may not be separated.

As shown in FIG. 2, the measurement principle of the disclosure is as follows. The schematic diagram of measuring the tilt angle of a reflection spot 19 between the single stacked sheet 18 below the multi-contact micro-reflector and the single stacked sheet 18 above the multi-contact micro-reflector is shown, where the tilt angle θ is an included angle between the tangent line 20 of the reflection spot 19 on the stacked sheet 18 below the multi-contact micro-reflector and a horizontal plane. The parameters required for the tilt angle θ of the reflection spot 19 are marked in the figure. In a camera display screen 21, h is a distance in which a light beam 23 reflected from the measurement light path to the camera 7 deflects in a Y direction relative to a light beam 22 reflected from the reference light path to the camera 7, h₁ is a distance (elevation data of the reflection spot 19) between the reflection spot 19 of the multi-reflector 9 and the reflection spot 19 of the single stacked sheet 18 below the multi-contact micro-reflector 9, and l₂ is a sum of a distance between the multi-contact micro-reflector 9 and the optical splitter 3 and a distance between the optical splitter 3 and the camera 7, which is l₂=l′₂+l₂″.

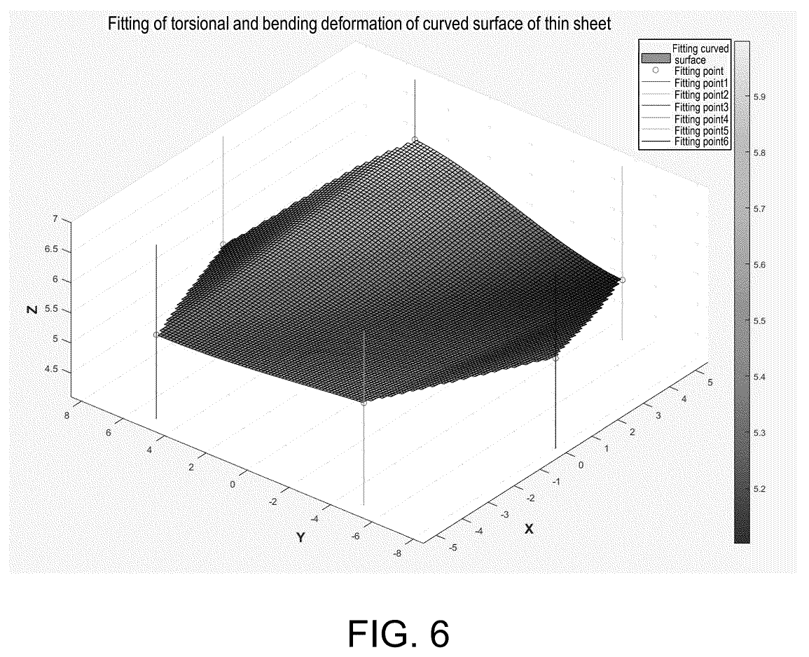

FIG. 6 is a diagram of a fitting result of torsional and bending deformation of a curved surface of a thin sheet, which is obtained by using the data measured by the device in FIG. 1. The elevation data of six points on the edges of two adjacent thin sheets of the stacked sheet is measured by the stacked sheet gap measurement device in FIG. 1. The torsional and bending deformation of the curved surface of the thin sheet is fitted by using a two-dimensional Griddata interpolation algorithm.

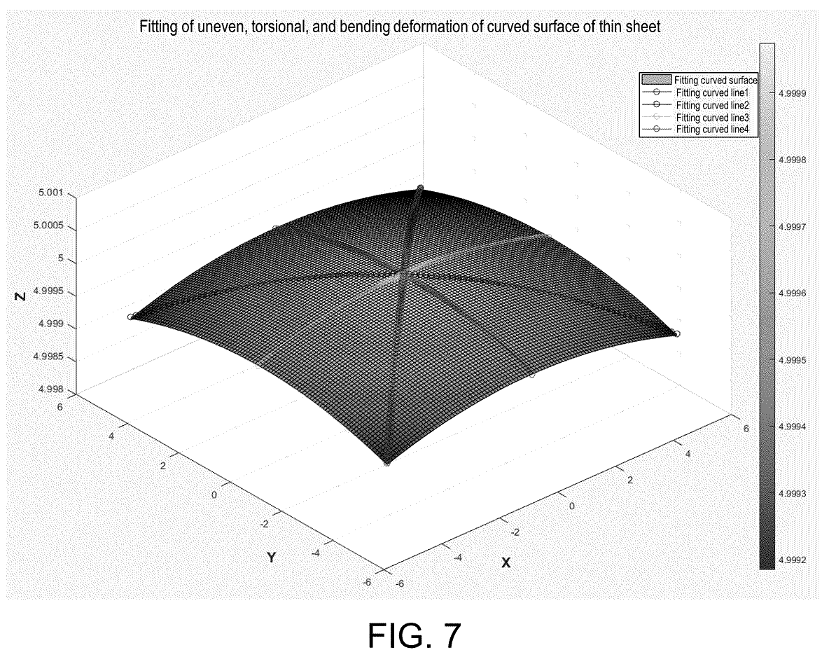

FIG. 7 is a diagram of a fitting result of uneven, torsional, and bending deformation of a curved surface of a thin sheet, which is obtained by using the data measured by the device in FIG. 1. The elevation data and inclination angles of eight points on the edges of two adjacent thin sheets of the stacked sheet are measured by the stacked sheet gap measurement device in FIG. 1. The uneven, torsional, and bending deformation of the curved surface of the thin sheet is fitted by using a cubic polynomial fitting algorithm.

In a second aspect of the disclosure, a method of measuring the gap between the stacked sheets is provided. The method includes the following steps. S1: the first translation stage and the second translation stage are respectively adjusted, so that a distance between the reflector and the optical splitter is equal to a distance between the multi-contact micro-reflector and the optical splitter. At this time, a position of the first translation stage is used as an initial position. S2: a position of the third translation stage is adjusted, so that the multi-contact micro-reflector is placed above the stacked sheet to be measured, and the camera generates multiple interference patterns of the measured stacked sheet. S3: The position of the first translation stage is adjusted. Multiple interference pattern signals in the camera are obtained. A distance between the multi-contact micro-reflector and the reflection spot on the surface of the stacked sheet to be measured is calculated, that is, an elevation value of the reflection spot on the surface of the stacked sheet to be measured. The above steps are repeated to find the elevation value of each reflection spot on the surface of the measured stacked sheet in turn. The elevation value is calculated by using the existing interference principle, which is not repeated here. S4: The third translation stage is rotated, and the rotation angle is recorded. The steps S1 to S3 are repeated until the elevation values of multiple reflection spots on the surface of each stacked sheet to be measured are obtained. S5: the elevation value of each reflection spot and the rotation angle of the third translation stage is used to fit all reflection spots to obtain the curved surface of the stacked sheet to be measured, and a determination whether the surface of the stacked sheet to be measured is deformed according to the fitted curved surface is made.

In step S3, the elevation is also used to calculate the inclination angle of the reflection spot. The tilt angle of the reflection spot is calculated according to the following relation:

$$θ = \frac{1}{2} arc tan ( \frac{2 h - \sqrt{2} {l}_{1}}{2 {l}_{2} - \sqrt{2} {l}_{1}} )$$

Furthermore, during the fitting process, the fitting method is determined according to the inclination angle of the reflection spot. If the inclination angle is less than a preset threshold, the two-dimensional Griddata interpolation algorithm is used for fitting, otherwise the cubic polynomial fitting algorithm is used.

The device provided by the disclosure uses the multi-contact micro-reflector 9 mounted on the second translation stage 8, so that the device reflects the light source 1 on the measurement light path 10 to the stacked sheet to be measured by the multi-contact micro-reflector 9, and reflects the reflected light on the stacked sheet to be measured to the light splitter 3, then changes a light path length by adjusting the first translation stage 4 in the reference light path 6 to obtain the interference patterns with wafer gap distance information in the observation camera. By adjusting the direction of the stacked sheet to be measured, the edge point data of the gaps between the stacked sheets may be measured, and the bending deformation of the stacked sheet may be fitted by using a fitting algorithm.

The measurement device of the disclosure includes the second translation stage located in an X direction of the measurement light path 10 without interfering with the positional relationship of other components on the measurement light path 10, and is configured to adjust the position and the direction of the measurement light path 10. Therefore, especially when the second translation stage is used in device adjustment stage, the position of the measurement light path 10 may be finely adjusted for convenience, so that the light source 1 from the optical splitter 3 may be aligned with the multi-contact micro-reflector 9.

Based on the measurement device of the disclosure, the measurement principle of the disclosure is that the light source 1 emits incoherent light which passes through the pinhole array mask and becomes several beams of parallel light, and the parallel light is then split into two beams by the optical splitter 3; one beam is incident on the reference light path 6, and the first translation stage 4 of the reference light path 6 is equipped with the reflector 5 to reflect the light beam; another beam is incident on the measurement light path 10, and the multi-contact micro-reflector 9 and the stacked sheet of the measurement light path 10 reflect the beam back. The reflected light on the reference light path 6 and the measurement light path 10 passes through the optical splitter 3 again and finally forms observable interference fringes in the camera. The light source 1 is turned on, and the translation stage of the measurement light path 10 is adjusted, so that light source 1 on the measurement light path 10 is incident on the multi-contact micro-reflector 9. At the same time, the first translation stage 4 of the reference light path 6 is adjusted, and the interference patterns are formed on the camera with the light reflected from the measurement light path 10. The reference light path 6, the first translation stage 4, and the observation camera are controlled by a computer program. When the first translation stage 4 is slowly and uniformly displaced, the interference light intensity of the observation camera is measured at regular time. The wafer gap is monitored and observed by measuring the change in the interference light intensity. All elements may be controlled by a computer. The light intensity data is converted into corresponding displacement data, and then the measurement results of the wafer gap are obtained according to the analysis and the evaluation of the displacement data.

It will be easily understood by people skilled in the art that the above description is only a preferred embodiment of the disclosure and is not intended to limit the disclosure. Any modifications, equivalent substitutions, and improvements made within the spirit and principles of the disclosure should be included in the protection scope of the disclosure.

1. A stacked sheet curved surface deformation measurement device based on a multi-contact micro-reflector, the measurement device comprising a light source, an array mask, an optical splitter, a reflector, a multi-contact micro-reflector, and a camera, wherein:
the optical splitter is disposed behind the light source, the array mask is disposed between the optical splitter and the light source, the reflector and the multi-contact micro-reflector are both disposed behind the optical splitter, and a stacked sheet to be measured is disposed behind the multi-contact micro-reflector;
the array mask is configured to divide light emitted by the light source into a plurality of beams of parallel incident light according to a distribution of the array mask, and one beam of light is configured to detect a curved surface deformation of a single stacked sheet, a plurality of micro-reflectors are disposed at a front end of the multi-contact micro-reflector, a single micro-reflector extends between adjacent stacked sheets to be measured for detection during a measurement process, and intervals between the plurality of micro-reflectors are set up according to gaps between the adjacent stacked sheets in the stacked sheet to be measured;
the light emitted by the light source is divided into several beams of parallel light by the array mask, and one of the beams of the parallel light is divided into two beams of light in different directions by the optical splitter, one beam enters the reflector to be reference light, and the other beam enters a micro-reflector of the multi-contact micro-reflector to be measurement light, the measurement light is reflected by the multi-contact micro-reflector, irradiates a surface of the stacked sheet to be measured, and is reflected by the stacked sheet to be measured, and the reflected light returns to the optical splitter along an original path, the reference light is reflected by the reflector and meanwhile enters the optical splitter, and the reference light and the measurement light are reflected by the optical splitter and enter the camera to merge to form an interference pattern.

2. The stacked sheet curved surface deformation measurement device based on the multi-contact micro-reflector according to claim 1, wherein a surface of the array mask has a linear array of pinholes, and a distance between pinhole arrays corresponds to a contact interval of the multi-contact micro-reflector.

3. The stacked sheet curved surface deformation measurement device based on the multi-contact micro-reflector according to claim 1, wherein the multi-contact micro-reflector comprises a substrate and a plurality of contacts disposed on the substrate, the substrate is made of a light-transmitting material, and a bottom surface of each of the plurality of contacts is in contact with a surface of the substrate.

4. The stacked sheet curved surface deformation measurement device based on the multi-contact micro-reflector according to claim 3, wherein the contact is a micro rectangular prism, a hypotenuse of the micro rectangular prism is a micro-reflector, light is incident from a side of the substrate, enters the micro-reflector from a right-angle edge of the micro rectangular prism, is reflected by the micro-reflector, and irradiates the surface of the stacked sheet to be measured, and the reflected light after being reflected by the surface of the stacked sheet to be measured irradiates the micro-reflector and returns along an original path.

5. The stacked sheet curved surface deformation measurement device based on the multi-contact micro-reflector according to claim 3, wherein the contact is a micro-channel prism, the micro-channel prism comprises two micro-channels, a connection section between the two micro-channels is a right-angled slope, the right-angled slope is a micro-reflector, light incident from the bottom surface of the substrate enters one of the two micro-channels, enters the other one of the two micro-channels after being reflected by the micro-reflector, and reaches the surface of the stacked sheet to be measured after propagating in the other one of the two micro-channels, and the reflected light after being reflected by the surface of the stacked sheet to be measured irradiates the micro-reflector and returns along an original path.

6. The stacked sheet curved surface deformation measurement device based on the multi-contact micro-reflector according to claim 3, wherein the substrate comprises a clamp part and a transition part, the clamp part is configured to clamp the contact, the transition part is configured to connect the contact and the clamp part, a micro-plane reflector is disposed at a front end of the contact, and the micro-plane reflector is a micro-reflector.

7. The stacked sheet curved surface deformation measurement device based on the multi-contact micro-reflector according to claim 6, wherein the micro-plane reflector is based on a brittle sheet material, a silver film or an aluminum film is coated on a surface, a layer of silicon dioxide protective film is attached to a surface of the silver film or the aluminum film, and a size of the contact is 1 um to 10 mm.

8. The stacked sheet curved surface deformation measurement device based on the multi-contact micro-reflector according to claim 1, wherein the stacked sheet to be measured is a stacked sheet object comprising a stacked semiconductor wafer, a stacked metal sheet, or a stacked chip.

9. The stacked sheet curved surface deformation measurement device based on the multi-contact micro-reflector according to claim 1, wherein the measurement device further comprises a first translation stage, a second translation stage, and a third translation stage, the first translation stage is disposed below the reflector for adjusting a position of the reflector, the second translation stage is disposed below the multi-contact micro-reflector for adjusting a position of the multi-contact micro-reflector, and the third translation stage is configured to place the stacked sheet to be measured, and a rotation or a movement of the third translation stage drives the stacked sheet to be measured to rotate or move.

10. A measuring method by the measurement device according to claim 1, wherein the method comprising following steps:
S1: adjusting positions of the reflector and the multi-contact micro-reflector to form a plurality of interference patterns in the camera, wherein each contact of the multi-contact micro-reflector is located between adjacent stacked sheets to be measured;
S2: calculating a distance between a reflection spot of light of the multi-contact micro-reflector and a reflection spot of light on the surface of the stacked sheet to be measured, which is an elevation value at the reflection spot on the surface of the stacked sheet to be measured;
S3: rotating the stacked sheet to be measured, recording a rotation angle, and repeating steps S1 to S2 until obtaining elevation values of a plurality of reflection spots on each surface of the stacked sheet to be measured;
S4: fitting the plurality of reflection spots to obtain a curved surface of the stacked sheet to be measured by using the elevation value of each reflection spot and the rotation angle, and determining whether the surface of the stacked sheet to be measured is deformed according to the fitting curved surface;
in step S3, the elevation is further used to calculate an inclination angle of the reflection spot, and the inclination angle of the reflection spot is calculated according to a following relation:
$$θ = \frac{1}{2} arc tan ( \frac{2 h - \sqrt{2} {l}_{1}}{2 {l}_{2} - \sqrt{2} {l}_{1}} )$$
wherein h is a distance in which the reflected light of the light path calculated by the camera deflects in a Y direction relative to the reflected light of the reference light path,
$${l}_{1} = {h}_{1} ( \frac{sin 2 θ}{sin ( \frac{π}{4} - 2 θ )} ) ,$$
h₁ is a distance in which a point of the light beam is incident on the multi-contact micro-reflector to a reflection spot of the stacked sheet to be measured, and l₂ is a sum of a distance between the multi-contact micro-reflector and the optical splitter and a distance between the optical splitter and the camera;
during a fitting process, a fitting method is further determined according to the inclination angle of the reflection spot, and a two-dimensional Griddata interpolation algorithm is used for fitting if the inclination angle is less than a preset threshold, otherwise, a cubic polynomial fitting algorithm is used.
